(19) United States
(12) Patent Application Publication
(10) Pub. No.: US 2024/0026931 A1
(43) Pub. Date: Jan. 25, 2024

(54) BEARING ASSEMBLY FOR STRUT ARRANGEMENT

(71) Applicant: Schaeffler Technologies AG & Co. KG, Herzogenaurach (DE)

(72) Inventors: Elias Ferreira Machado, Sorocaba (BR); Kleberson Sierra, Sorocaba (BR)

(73) Assignee: Schaeffler Technologies AG & Co. KG, Herzogenaurach (DE)

(21) Appl. No.: 17/867,980

(22) Filed: Jul. 19, 2022

(51) Int. Cl. F16C 43/04; F16C 19/10; F16C 35/04; F16C 33/76

(52) U.S. Cl. CPC F16C 43/04; F16C 19/10; F16C 35/042; F16C 33/761; F16C 33/768; F16C 2326/05; B60G 15/067

(57) ABSTRACT

A strut bearing assembly and an improved cap for a strut bearing assembly is disclosed herein. The cap defines a first bearing pocket half dimensioned to receive a first portion of a bearing assembly, a radially outer edge defining a first mating element configured to mate with a first portion of a top mount, and a radially inner projection defining a bearing surface configured to abut a second portion of a top mount. The top mount component can generally be configured to attach to a car body. The strut bearing assembly can include a guide ring including a guide sleeve configured to provide an interface for a shock absorber spring. The guide ring can define a second bearing pocket half dimensioned to receive a second portion of a bearing assembly.

### FIELD OF INVENTION

The present disclosure relates to a strut arrangement, and more particularly relates to a bearing assembly for a strut arrangement.

### BACKGROUND

Strut configurations and arrangements are well known and typically used in a McPherson suspension system. Within these struts and suspension systems, bearing assemblies are provided at an interface between a top mount component that attaches to a vehicle body, and a shock absorber spring.

FIG. 1A illustrates one such configuration, which includes a strut bearing 1, a portion of a car body 2, a top mount component 3, a shock absorber 4, a shock absorber spring 5, and a bump stop 6.

FIG. 1B shows another specific configuration including a bearing guide ring 7, a top mount 8, and a top cap 9.

Within these known configurations, it would be desirable to provide an improved interface between the top cap and the bushing or other top mounting component. Specifically, it is desirable to provide a cap component that can withstand bump stop and shock absorber loads.

### SUMMARY

A strut bearing assembly and an improved cap for a strut bearing assembly is disclosed herein. The strut bearing assembly can include a cap defining a first bearing pocket half dimensioned to receive a first portion of a bearing assembly, a radially outer edge defining a first mating element configured to mate with a first portion of a top mount, and a radially inner projection defining a bearing surface configured to abut a second portion of a top mount. The top mount component can generally be configured to attach to a car body. The strut bearing assembly can include a guide ring including a guide sleeve configured to provide an interface for a shock absorber spring. The guide ring can define a second bearing pocket half dimensioned to receive a second portion of a bearing assembly.

The bearing surface of the cap can have a flat profile and is configured to engage with a bushing element or other aspect of the top mount. The bearing surface can have a radial extent based on the application load requirements.

The cap can further comprise a first retention element, and the guide ring can further comprise a second retention element configured to engage with the first retention element to secure the cap with the guide ring. The first retention element can be defined radially outward from the bearing surface.

A shield can be provided that is configured to attach to the cap and cover the bearing surface. The shield can be formed from metal, and the cap can be formed from thermoplastic. One of ordinary skill in the art would understand that other materials can be used to form these components.

The shield can be configured to attach to the cap via an interference fit or snap fit.

A bump stop can be provided that is configured to contact a support surface defined on a surface of the radially inner projection opposite from the bearing surface. The guide ring can define a central opening dimensioned to receive a portion of the bump stop such that the bump stop extends through the guide ring.

The first mating element can be defined as a shoulder that is oriented perpendicular to an axis (X) of the cap. The cap can further comprise a recess defined adjacent to the first mating element, and the recess is defined radially inward relative to a remainder of the outer edge of the cap.

The cap and the guide ring can both be formed via injection molding. The cap can include a plurality of reliefs defined in regions away from the radially inner projection. This ensures a suitable bearing surface for engagement with the top mount.

The guide ring can include a support flange extending radially inward that is configured to engage with a bump stop. The support flange of the guide ring and the radially inner projection of the cap can overlap in an axial direction.

In another embodiment, a cap for a strut bearing assembly is disclosed. The cap can include a first bearing pocket half dimensioned to receive a first portion of a bearing assembly, a radially outer edge defining a first mating element configured to mate with a first portion of a top mount, and a radially inner projection defining a bearing surface configured to abut a second portion of a top mount. The cap can be configured to mate with a guide ring.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1A is a cross-sectional view of one suspension system according to the prior art.

FIG. 1B is a cross-sectional view of a strut bearing assembly according to the prior art.

FIG. 2A is a cross-sectional view of a strut bearing assembly according to one embodiment.

FIG. 2B is a magnified cross-sectional view of the strut bearing assembly of FIG. 2A.

FIG. 3A is a bottom view of a top cap for the strut bearing assembly. FIG. 3B is a top view of a guide ring for the strut bearing assembly.

FIG. 3C is a bottom perspective view of the top cap and the guide ring in an assembled state.

FIG. 3D is a side perspective view of the top cap and the guide ring in the assembled state.

FIG. 3E is a cross-sectional perspective view of the top cap and the guide ring in the assembled state.

FIG. 4A is a cross-sectional view of an outer edge of the top cap according to one embodiment.

FIG. 4B is a cross-sectional view of the outer edge of the top cap according to another embodiment.

FIG. 5 is a cross-sectional view of a top cap, guide ring, and bump stop.

FIG. 6A is a top perspective view of a top cap.

FIG. 6B is a cross-sectional view of the top cap assembled with the guide ring and a shield.

FIG. 6C is a top perspective view of the top cap, guide ring, and the shield from FIG. 6B.

### DETAILED DESCRIPTION OF THE PREFERRED EMBODIMENTS

Certain terminology is used in the following description for convenience only and is not limiting. “Axially” refers to a direction along an axis (X) of an assembly. “Radially” refers to a direction inward and outward from the axis (X) of the assembly.

A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

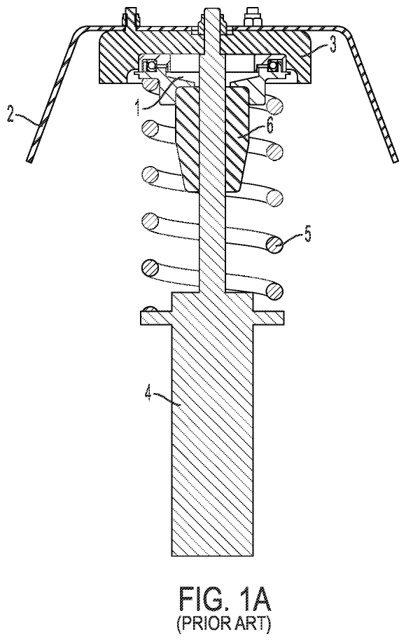

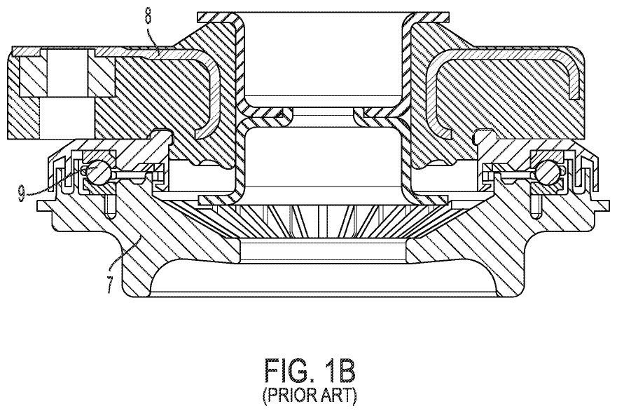

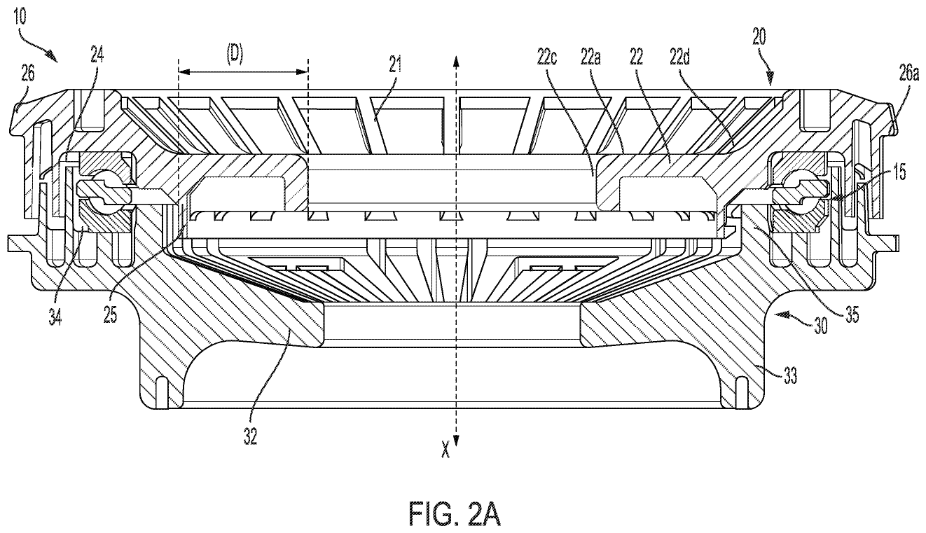

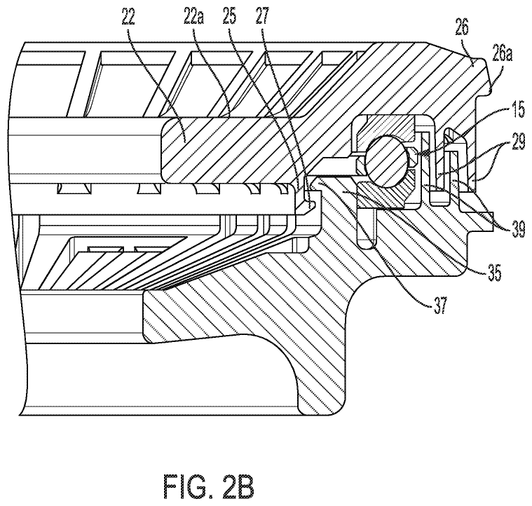

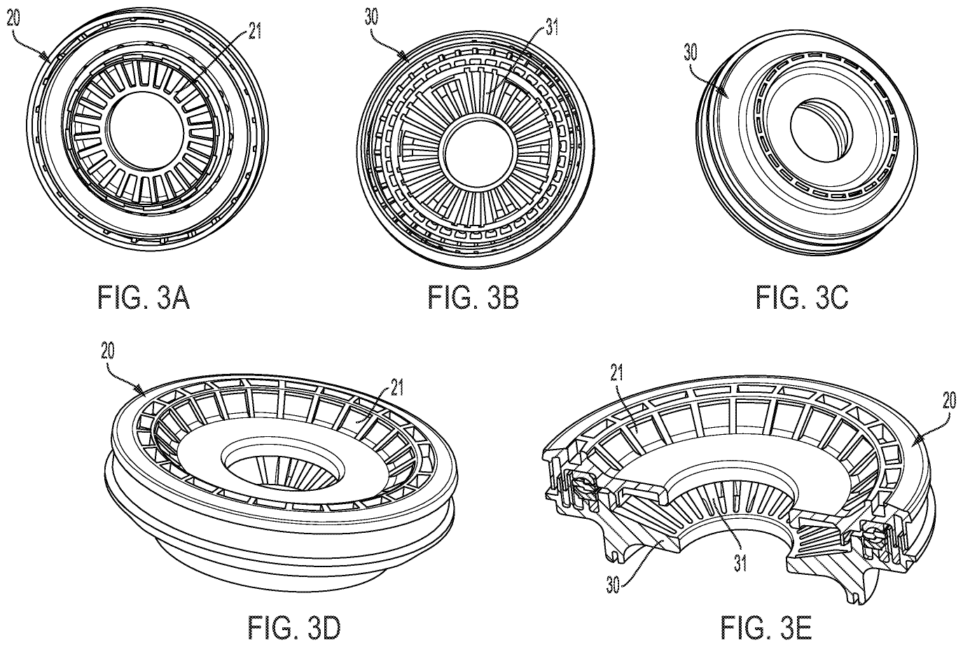

As shown in FIGS. 2A and 2B, a strut bearing assembly 10 is disclosed. The strut bearing assembly 10 generally includes a cap 20, a guide ring 30, and a bearing assembly 15. These components each rotate about a common axis (X) as shown in FIG. 2A. The cap 20 is generally configured to engage with a top mount, which may include a bushing or bearing interface. The top mount can also include a retainer or retention component configured to attach to the cap 20. The top mount can generally be configured to be connected to the car body, as shown in FIG. 1A.

The guide ring 30 generally provides an interface with a shock absorber spring (i.e. element 5 from FIG. 1). The guide ring 30 can be formed from a thermoplastic material, such as PA6 or PA66. The bearing assembly 15 can include bearing rings and rolling elements supported therebetween, as well as a cage to support the rolling elements. The bearing assembly 15 can also be a plain bearing assembly or any other type of bearing, as is well known to one of ordinary skill in the art.

The cap 20 can be formed from a thermoplastic material, such as PA6 or PA66. The cap 20 can define a first bearing pocket half 24 dimensioned to receive a first portion of the bearing assembly 15 (i.e. at least an upper bearing ring and a portion of the rolling elements). The cap 20 can include a radially outer edge 26 defining a first mating element 26a configured to mate with a top mount. In one aspect, the first mating element 26a defines a lip or shoulder for engagement with a retainer formed on the top mount.

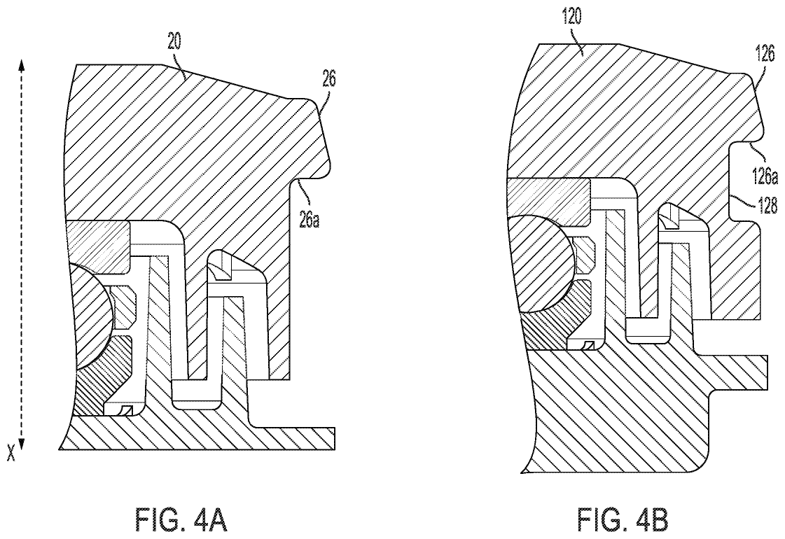

As shown in further detail in FIG. 4A, the first mating element 26a can be defined as a shoulder oriented perpendicular to the axis (X). Referring to FIG. 4B, the cap 120 can further comprise a recess 128 defined adjacent to the first mating element 126a. The recess 128 can be defined radially inward relative to a remainder of the outer edge 126 of the cap 120. The first mating element formed on the cap can have varying shapes and profiles depending on the corresponding geometry of mating or retention elements formed on the top mount.

The cap 20 can also include a radially inner projection 22 defining a bearing surface 22a configured to engage a portion of the top mount. In one configuration, the bearing surface 22a is configured to define a bearing interface for engagement with a bushing or other bearing element. The bearing surface 22a can have a generally smooth or flat profile that extends perpendicular to the axis (X). A depth or extent of the bearing surface 22a is configured to be sufficient to accommodate engagement with a bushing, bearing or other contact face formed on the top mount.

The guide ring 30 can define a second bearing pocket half 34 dimensioned to receive a second portion of a bearing assembly 15 (i.e. at least a lower bearing ring and a portion of the rolling elements). The guide ring 30 can include a guide sleeve 33 that is configured to provide a guiding interface for the shock absorber spring.

The bearing surface 22a can be configured to engage with a bushing element, bearing element, or other interface. The bearing surface 22a generally defines a planar, uninterrupted surface between a radially innermost edge 22c of the cap 20 and an inclined portion 22d of the cap 20. In one configuration, the bearing surface 22a has a radial extent (D) which is designed based on the application requirements. In one example, the bearing surface 22a can have a radial extent (D) that is at least 10 mm. One of ordinary skill in the art would understand that the radial extent (D) can vary according to the top mount design and application load.

The cap 20 and the guide ring 30 are configured to be attached or connected to each other. The cap 20 can include a first retention element 27 defined on an axial protrusion 25, and the guide ring 30 can include a second retention element 37 defined on an axial projection 35 that is configured to engage with the first retention element 27 to secure the cap 20 with the guide ring 30. This provides a snap-fit connection between the cap 20 and the guide ring 30. Additional interfacing features, as shown radially outward from the bearing assembly 15 via the multiple interfacing or interlocking fingers 29, 39 formed on the cap 20 and the guide ring 30 can also be provided. The first retention element 27 on the cap 20 can be defined radially outward relative to the bearing surface 22a, as well as on an opposite axial side of the cap 20. The axial protrusion 25 can be formed directly on an underside of the radially inner projection 22.

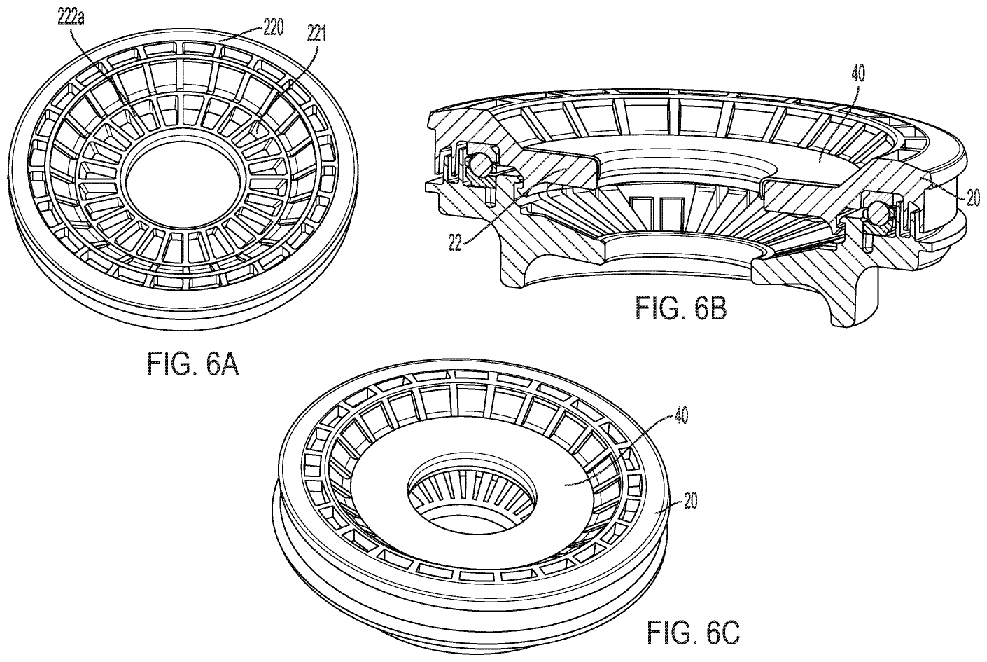

The cap 20 and the guide ring 30 can both be formed via injection molding. Based on this formation process, the cap 20 can include reliefs 21 and the guide ring 30 can include reliefs 31. These reliefs 21, 31 can be provided or defined on the cap 20 and the guide ring 30 in regions away from interfacing, bearing, or other surfaces or regions that provide some function. In one configuration, the cap 20 includes a plurality of reliefs 21 defined in regions away from the radially inner projection 22 and the bearing surface 22a. As shown in FIGS. 6A-6C, the reliefs 221 can be defined in a region of the bearing surface 222a, and a shield 40 can be attached to ensure a continuous, non-interrupted contact or bearing surface for the top mount, as described in more detail below.

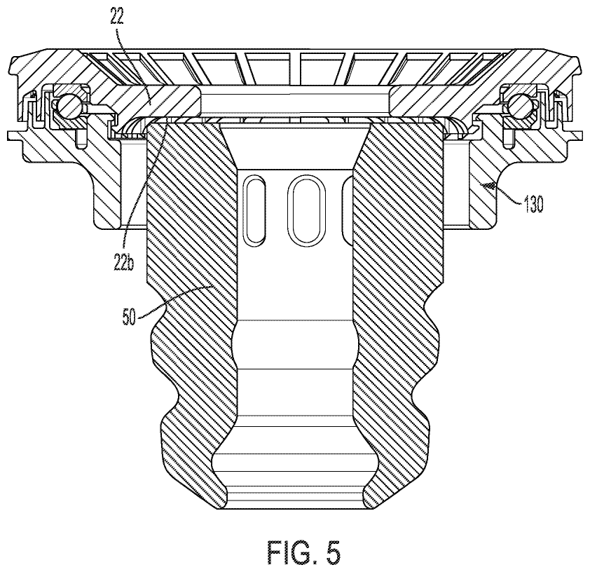

As shown in FIG. 5, a bump stop 50 can be provided. The bump stop 50 can be configured to engage a support flange 32 formed on the guide ring 30. The support flange 32 can extend radially inward and can overlap with the radially inner projection 22 on the cap 20 in an axial direction.

In another configuration, the bump stop 50 can be configured to contact a support surface 22b defined on the radially inner projection 22 of the cap 20 on an opposite side from the bearing surface 22a. In this manner, the cap 20 can provide an interface for both the bump stop 50 on a bottom side or surface and the top mount on a top side or surface. Referring to FIG. 5, the guide ring 130 can define a central opening dimensioned to receive a portion of the bump stop 50 such that the bump stop 50 extends through the guide ring 130.

Referring to FIGS. 6A-6C, in one configuration, a shield 40 can be provided to protect or cover the bearing surface of the cap. The shield 40 can be formed from metal or some other suitable and durable material that is capable of withstanding contact with the top mount. As shown in FIGS. 6A-6C, the cap 220 can include a bearing surface 222a that is not continuously flat and uniform, and instead includes reliefs 221. To provide a stable and flat bearing surface 222a, the shield 40 can be attached to the cap 220. Various connection or attachment configurations can be provided for securing the shield 40 to the cap 220. For example, the shield 40 can be configured to attach to the cap via an interference fit or snap fit. The shield 40 is shown in FIGS. 6A-6C, but can be attached to the cap shown in any of the Figures.

Having thus described the present disclosure in detail, it is to be appreciated and will be apparent to those skilled in the art that many physical changes, only a few of which are exemplified in the detailed description of the invention, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the embodiments being indicated by the appended claims rather than by the foregoing description, and all alternate embodiments and changes to this embodiment which come within the meaning and range of equivalency of said claims are therefore to be embraced therein.

Log of Reference Numerals

Strut bearing 1

Car body 2

Top mount 3

Shock absorber 4

Shock absorber spring 5

Bump stop 6

Bearing guide ring 7

Top mount 8

Top cap 9

Strut bearing assembly 10

Bearing assembly 15

Cap 20, 120, 220

Reliefs 21, 221

Radially inner projection 22

Bearing surface 22a, 222a

Support surface 22b

Radially innermost edge 22c

Inclined portion 22d

First bearing pocket half 24

Axial protrusion 25

Radially outer edge 26, 126

First mating element 26a, 126a

First retention element 27

Fingers 29

Guide ring 30, 130

Reliefs 31

Support flange 32

Guide sleeve 33

Second bearing pocket half 34

Axial projection 35

Second retention element 37

Finger 39

Shield 40

Bump stop 50

Recess 128

What is claimed is:

1. A strut bearing assembly comprising:
a cap defining a first bearing pocket half dimensioned to receive a first portion of a bearing assembly, a radially outer edge defining a first mating element configured to mate with a first portion of a top mount, and a radially inner projection defining a bearing surface configured to abut a second portion of a top mount; and
a guide ring including a guide sleeve configured to provide an interface for a shock absorber spring, the guide ring defining a second bearing pocket half dimensioned to receive a second portion of a bearing assembly.

2. The strut bearing assembly according to claim 1, wherein the bearing surface has a flat profile and is configured to engage with a bushing element.

3. The strut bearing assembly according to claim 1, wherein the bearing surface has a radial extension that is at least 10 mm.

4. The strut bearing assembly according to claim 1, wherein the cap further comprises a first retention element, and the guide ring further comprises a second retention element configured to engage with the first retention element to secure the cap with the guide ring, wherein the first retention element is defined radially outward from the bearing surface.

5. The strut bearing assembly according to claim 1, further comprising a shield configured to attach to the cap and cover the bearing surface.

6. The strut bearing assembly according to claim 5, wherein the shield is formed from metal, and the cap is formed from thermoplastic.

7. The strut bearing assembly according to claim 5, wherein the shield is configured to attach to the cap via an interference fit or snap fit.

8. The strut bearing assembly according to claim 1, further comprising a bump stop configured to contact a support surface defined on a surface of the radially inner projection opposite from the bearing surface.

9. The strut bearing assembly according to claim 8, wherein the guide ring defines a central opening dimensioned to receive a portion of the bump stop such that the bump stop extends through the guide ring.

10. The strut bearing assembly according to claim 1, wherein the first mating element is defined as a shoulder that is oriented perpendicular to an axis (X) of the cap.

11. The strut bearing assembly according to claim 1, wherein the cap further comprises a recess defined adjacent to the first mating element, and the recess is defined radially inward relative to a remainder of the radially outer edge of the cap.

12. The strut bearing assembly according to claim 1, wherein the cap and the guide ring are both formed via injection molding.

13. The strut bearing assembly according to claim 12, wherein the cap includes a plurality of reliefs defined in regions away from the radially inner projection.

14. The strut bearing assembly according to claim 1, the guide ring includes a support flange extending radially inward that is configured to engage with a bump stop.

15. The strut bearing assembly according to claim 14, wherein the support flange of the guide ring and the radially inner projection of the cap overlap in an axial direction.

16. A cap for a strut bearing assembly, the cap comprising:
a first bearing pocket half dimensioned to receive a first portion of a bearing assembly;
a radially outer edge defining a first mating element configured to mate with a first portion of a top mount; and
a radially inner projection defining a bearing surface configured to abut a second portion of a top mount.

17. The cap according to claim 16, wherein the cap further comprises a support surface defined on a surface of the radially inner projection opposite from the bearing surface, and the support surface is configured to engage with a bump stop.

18. The cap according to claim 16, wherein the cap is formed via injection molding, and the cap includes a plurality of reliefs defined in regions away from the radially inner projection.

19. The cap according to claim 16, wherein the cap further comprises a recess defined adjacent to the first mating element, and the recess is defined radially inward relative to a remainder of the radially outer edge of the cap.

20. The cap according to claim 16, wherein the cap further comprises a first retention element configured to engage with a retention element formed on a guide ring to secure the cap with the guide ring, wherein the first retention element is defined radially outward from the bearing surface.
